(19) United States
(12) Patent Application Publication
(10) Pub. No.: US 2022/0374782 A1
(43) Pub. Date: Nov. 24, 2022

(54) METHOD AND SYSTEM FOR PROVIDING COUNTERFACTUAL EXPLANATIONS FOR ARTIFICIAL INTELLIGENCE REGRESSION MODELS

(71) Applicant: JPMorgan Chase Bank, N.A., New York, NY (US)

(72) Inventors: Thomas SPOONER, London (GB); Danial DERVOVIC, London (GB); Jason LONG, Fen Drayton (GB); Jiahao CHEN, New York, NY (US); Jonathan SHEPARD, New York, NY (US); Daniele MAGAZZENI, London (GB)

(73) Assignee: JPMorgan Chase Bank, N.A., New York, NY (US)

(21) Appl. No.: 17/326,625

(22) Filed: May 21, 2021

(51) Int. Cl. G06N 20/20; G06N 5/04

(52) U.S. Cl. CPC G06N 20/20; G06N 5/045

(57) ABSTRACT

A method and a system for generating a counterfactual explanation for an artificial intelligence (AI) regression model are provided. The method includes: obtaining a mathematical expression that corresponds to the AI regression model and a first value that corresponds to a query instance; and defining a counterfactual potential function by performing a differential continuous mapping between respective output values of the obtained mathematical expression and a real line over a predetermined subset of real numbers. The counterfactual explanation is generated based on a value of the obtained mathematical expression that corresponds to a maximum value of the determined at least one counterfactual potential function.

### BACKGROUND

### 1. Field of the Disclosure

This technology relates to methods and systems for providing counterfactual explanations for decisions made by artificial intelligence regression models.

### 2. Background Information

Counterfactual explanations have garnered attention in the explainable artificial intelligence (XAI) literature as a tool for inspecting the outputs of machine learning models. In its most basic form, a counterfactual explanation of a model f takes an input query instance x belonging to an input data space and applies the minimal perturbation to the query instance such that the perturbed model output f(x+e) differs from the original output f(x) in some desired way. The ability to inspect local changes in a model's output allows one to understand a decision boundary in more detail, diagnose issues with robustness or to suggest ways consumers of a model's output can improve their own model-dependent outcomes, i.e., actionable recourse.

In the classification setting, particularly for binary outputs, it is clear that the notion of model outputs “differing” from one another corresponds to differing class labels. However, in the case of regression, it is not so clear. Indeed, for many regression models, model outputs may differ under arbitrarily small perturbations. Applying the common definition of a counterfactual for regression models can thus give rise to counterfactuals conveying little useful information to users by dint of their being too similar to the query instance. One can envisage trying to mitigate this by introducing a minimal distance threshold on the dependent variable, so that a valid counterfactual has an output bounded away from the query instance's output. Under this scheme, returned counterfactuals can be very sensitive to this threshold. However, such problems are known to be computationally difficult to solve optimally.

Accordingly, there is a need to address the challenge of computing counterfactual explanations for artificial intelligence (AI) regression models in a principled, flexible manner.

### SUMMARY

The present disclosure, through one or more of its various aspects, embodiments, and/or specific features or sub-components, provides, inter alia, various systems, servers, devices, methods, media, programs, and platforms for providing counterfactual explanations for decisions made by artificial intelligence regression models.

According to an aspect of the present disclosure, a method for generating a counterfactual explanation for an artificial intelligence (AI) regression model is provided. The method is implemented by at least one processor. The method includes: obtaining, by the at least one processor, a mathematical expression that corresponds to the AI regression model and a first value that corresponds to a query instance; defining, by the at least one processor, at least one candidate counterfactual potential function by performing a differential continuous mapping between respective output values of the obtained mathematical expression and a real line over a predetermined subset of real numbers; and generating the counterfactual explanation based on at least one respective value of the obtained mathematical expression that corresponds to a maximum value of the defined at least one candidate counterfactual potential function.

The generating of the counterfactual explanation may further include: selecting, from among a predetermined set of possible input data points, a first data point to be used as an input to the obtained mathematical expression; computing a corresponding output value of the obtained mathematical expression based on the selected first data point; determining whether the computed corresponding output value corresponds to a predetermined optimum potential value; and when the computed corresponding output value is determined as corresponding to the predetermined optimum potential value, generating the counterfactual explanation based on the selected first data point.

When the computed corresponding output value is determined as not corresponding to the predetermined optimum potential value, the method may further include: selecting a next data point from among the predetermined set of possible input data points to be used as an input to the obtained mathematical expression; computing a next corresponding output value of the obtained mathematical expression based on the selected next data point; determining whether the next computed corresponding output value corresponds to the predetermined optimum potential value; when the next computed corresponding output value is determined as corresponding to the predetermined optimum potential value, generating the counterfactual explanation based on the most recently selected next data point; and when the next computed corresponding output value is determined as not corresponding to the predetermined optimum potential value, repeating the selecting, computing, and determining steps for additional next data points until the computed corresponding value is determined as corresponding to the predetermined optimum potential value.

The method may further include receiving, by the at least one processor from a user, an input value designated by the user for generating the counterfactual explanation. The defining of the at least one candidate counterfactual potential function may include performing the differential continuous mapping between the respective output values of the obtained mathematical expression and the real line over the predetermined subset of real numbers such that the input value designated by the user corresponds to the maximum value of the defined at least one candidate counterfactual potential function.

The defining of the at least one candidate counterfactual potential function may further include: determining a plurality of candidate counterfactual potential functions; optimizing the determined plurality of candidate counterfactual potential functions with respect to the input value designated by the user; and generating the counterfactual potential function based on a result of the optimizing.

The optimizing may include using Bayesian optimization to perform the optimizing.

The determining of the plurality of candidate counterfactual potential functions may include defining a plurality of exponential-polynomial functions of the input value designated by the user.

The AI regression model may receive inputs that correspond to features that relate to a credit history of a customer and may generate an output that corresponds to a predicted probability of default by the customer.

The AI regression model may include at least one from among a neural network model, a logistic regression model, and a random forest model.

According to another exemplary embodiment, a computing apparatus for generating a counterfactual explanation for an artificial intelligence (AI) regression model is provided. The computing apparatus includes a processor; a memory; and a communication interface coupled to each of the processor and the memory. The processor is configured to: obtain a mathematical expression that corresponds to the AI regression model and a first value that corresponds to a query instance; define at least one candidate counterfactual potential function by performing a differential continuous mapping between respective output values of the obtained mathematical expression and a real line over a predetermined subset of real numbers; and generate the counterfactual explanation based on at least one respective value of the obtained mathematical expression that corresponds to a maximum value of the defined at least one candidate counterfactual potential function.

The processor may be further configured to generate the counterfactual explanation by: selecting, from among a predetermined set of possible input data points, a first data point to be used as an input to the obtained mathematical expression; computing a corresponding output value of the obtained mathematical expression based on the selected first data point; determining whether the computed corresponding output value corresponds to a predetermined optimum potential value; and when the computed corresponding output value is determined as corresponding to the predetermined optimum potential value, generating the counterfactual explanation based on the selected first data point.

When the computed corresponding output value is determined as not corresponding to the predetermined optimum potential value, the processor may be further configured to: select a next data point from among the predetermined set of possible input data points to be used as an input to the obtained mathematical expression; compute a next corresponding output value of the obtained mathematical expression based on the selected next data point; determine whether the next computed corresponding output value corresponds to the predetermined optimum potential value; when the next computed corresponding output value is determined as corresponding to the predetermined optimum potential value, generate the counterfactual explanation based on the most recently selected next data point; and when the next computed corresponding output value is determined as not corresponding to the predetermined optimum potential value, repeat the selecting, computing, and determining operations for additional next data points until the computed corresponding value is determined as corresponding to the predetermined optimum potential value.

The processor may be further configured to: receive, from a user via the communication interface, an input value designated by the user for generating the counterfactual explanation; and define the at least one candidate counterfactual potential function by performing the differential continuous mapping between the respective output values of the obtained mathematical expression and the real line over the predetermined subset of real numbers such that the input value designated by the user corresponds to the maximum value of the defined at least one candidate counterfactual potential function.

The processor may be further configured to define the at least one candidate counterfactual potential function by: determining a plurality of candidate counterfactual potential functions; optimizing the determined plurality of candidate counterfactual potential functions with respect to the input value designated by the user; and generating the counterfactual explanation based on a result of the optimizing.

The processor may be further configured to use Bayesian optimization to perform the optimization.

The processor may be further configured to determine the plurality of candidate counterfactual potential functions by defining a plurality of exponential-polynomial functions of the input value designated by the user.

The AI regression model may receive inputs that correspond to features that relate to a credit history of a customer and may generate an output that corresponds to a predicted probability of default by the customer.

The AI regression model may include at least one from among a neural network model, a logistic regression model, and a random forest model.

According to yet another exemplary embodiment, a non-transitory computer readable storage medium storing instructions for generating a counterfactual explanation for an artificial intelligence (AI) regression model is provided. The storage medium includes executable code which, when executed by a processor, causes the processor to: obtain a mathematical expression that corresponds to the AI regression model and a first value that corresponds to a query instance; define at least one candidate counterfactual potential function by performing a differential continuous mapping between respective output values of the obtained mathematical expression and a real line over a predetermined subset of real numbers; and generate the counterfactual explanation based on at least one respective value of the obtained mathematical expression that corresponds to a maximum value of the defined at least one candidate counterfactual potential function.

The executable code may be further configured to cause the processor to: select, from among a predetermined set of possible input data points, a first data point to be used as an input to the obtained mathematical expression; compute a corresponding output value of the obtained mathematical expression based on the selected first data point; determine whether the computed corresponding output value corresponds to a predetermined optimum potential value; and when the computed corresponding output value is determined as corresponding to the predetermined optimum potential value, generate the counterfactual explanation based on the selected first data point.

When the computed corresponding output value is determined as not corresponding to the predetermined optimum potential value, the executable code may be further configured to cause the processor to: select a next data point from among the predetermined set of possible input data points to be used as an input to the obtained mathematical expression; compute a next corresponding output value of the obtained mathematical expression based on the selected next data point; determine whether the next computed corresponding output value corresponds to the predetermined optimum potential value; when the next computed corresponding output value is determined as corresponding to the predetermined optimum potential value, generate the counterfactual explanation based on the most recently selected next data point; and when the next computed corresponding output value is determined as not corresponding to the predetermined optimum potential value, repeat the selecting, computing, and determining steps for additional next data points until the computed corresponding value is determined as corresponding to the predetermined optimum potential value.

The executable code may be further configured to cause the processor to: receive, from a user, an input value designated by the user for generating the counterfactual explanation; and define the at least one candidate counterfactual potential function by performing the differential continuous mapping between the respective output values of the obtained mathematical expression and the real line over the predetermined subset of real numbers such that the input value designated by the user corresponds to the maximum value of the defined at least one candidate counterfactual potential function.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing counterfactual explanations for decisions made by artificial intelligence regression models.

FIG. 4 is a flowchart of an exemplary process for implementing a method for providing counterfactual explanations for decisions made by artificial intelligence regression models.

FIG. 5 is a graphical depiction of an exponential-polynomial potential function that is optimizable for defining a counterfactual potential function, according to an exemplary embodiment.

FIG. 6 is a graphical illustration of a sensitivity of defining a counterfactual for regression via a threshold, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

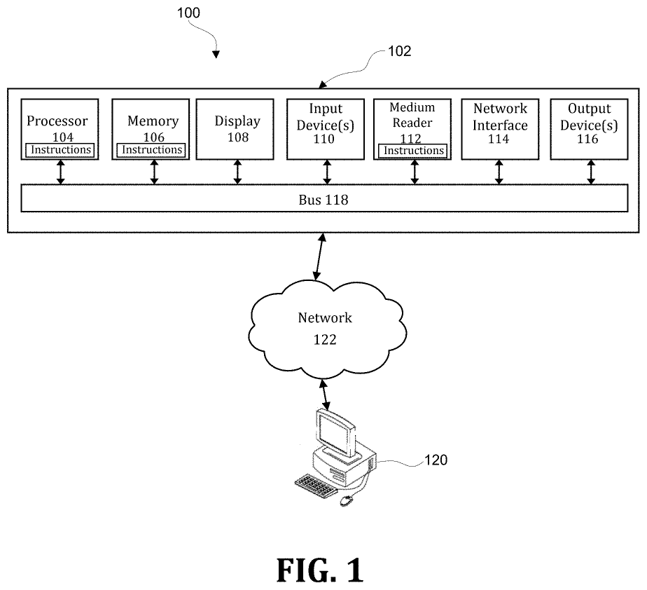

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing counterfactual explanations for decisions made by artificial intelligence regression models.

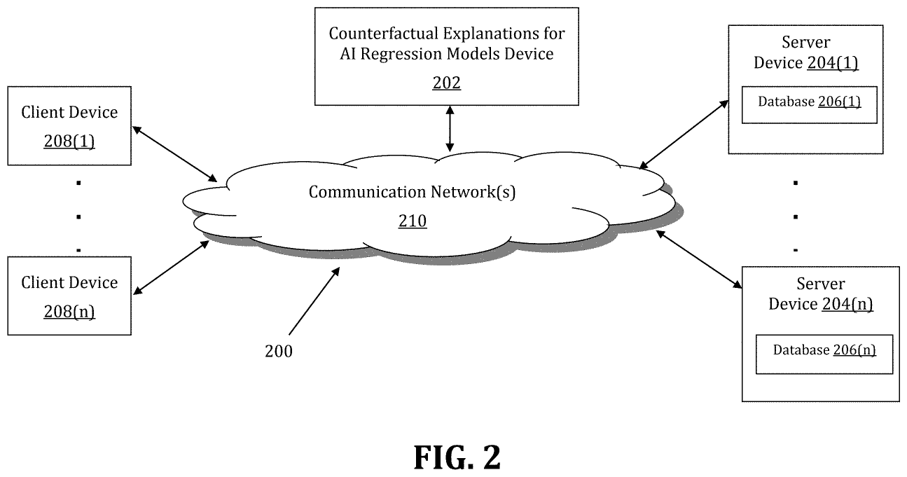

Referring to FIG. 2, a schematic of an exemplary network environment 200 for implementing a method for providing counterfactual explanations for decisions made by artificial intelligence regression models is illustrated. In an exemplary embodiment, the method is executable on any networked computer platform, such as, for example, a personal computer (PC).

The method for providing counterfactual explanations for decisions made by artificial intelligence regression models may be implemented by a Counterfactual Explanations for Artificial Intelligence Regression Models (CEAIRM) device 202. The CEAIRM device 202 may be the same or similar to the computer system 102 as described with respect to FIG. 1. The CEAIRM device 202 may store one or more applications that can include executable instructions that, when executed by the CEAIRM device 202, cause the CEAIRM device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CEAIRM device 202 itself, may be located in virtual server(s) running in a cloud-based computing environment rather than being tied to one or more specific physical network computing devices. Also, the application(s) may be running in one or more virtual machines (VMs) executing on the CEAIRM device 202. Additionally, in one or more embodiments of this technology, virtual machine(s) running on the CEAIRM device 202 may be managed or supervised by a hypervisor.

In the network environment 200 of FIG. 2, the CEAIRM device 202 is coupled to a plurality of server devices 204(1)-204(n) that hosts a plurality of databases 206(1)-206(n), and also to a plurality of client devices 208(1)-208(n) via communication network(s) 210. A communication interface of the CEAIRM device 202, such as the network interface 114 of the computer system 102 of FIG. 1, operatively couples and communicates between the CEAIRM device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CEAIRM device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CEAIRM devices that efficiently implement a method for providing counterfactual explanations for decisions made by artificial intelligence regression models.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CEAIRM device 202 may be a standalone device or integrated with one or more other devices or apparatuses, such as one or more of the server devices 204(1)-204(n), for example. In one particular example, the CEAIRM device 202 may include or be hosted by one of the server devices 204(1)-204(n), and other arrangements are also possible. Moreover, one or more of the devices of the CEAIRM device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CEAIRM device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to AI regression models and data that relates to counterfactual explanations generated by Bayesian search.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CEAIRM device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CEAIRM device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CEAIRM device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CEAIRM device 202, the server devices 204(1)-204(n), or the client devices 208(1)-208(n), for example, may be configured to operate as virtual instances on the same physical machine. In other words, one or more of the CEAIRM device 202, the server devices 204(1)-204(n), or the client devices 208(1)-208(n) may operate on the same physical device rather than as separate devices communicating through communication network(s) 210. Additionally, there may be more or fewer CEAIRM devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

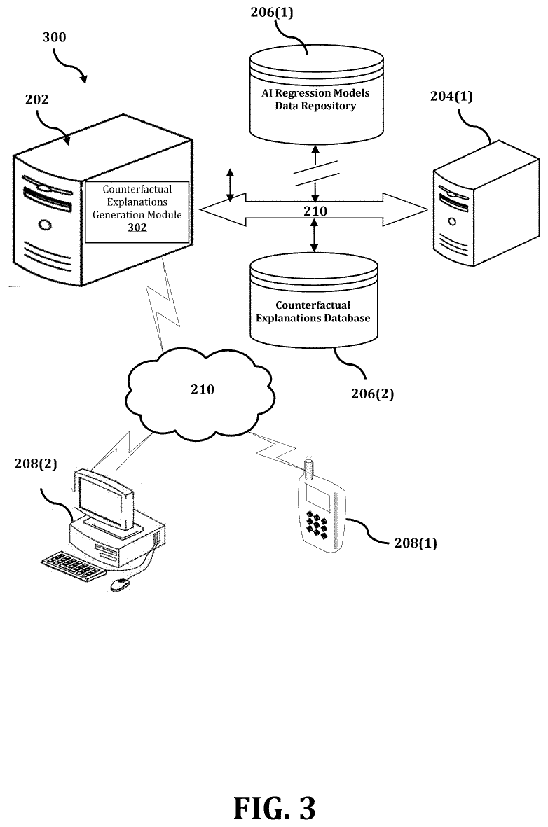

The CEAIRM device 202 is described and illustrated in FIG. 3 as including a counterfactual explanations generation module 302, although it may include other rules, policies, modules, databases, or applications, for example. As will be described below, the counterfactual explanations generation module 302 is configured to implement a method for providing counterfactual explanations for decisions made by artificial intelligence regression models.

An exemplary process 300 for implementing a mechanism for providing counterfactual explanations for decisions made by artificial intelligence regression models by utilizing the network environment of FIG. 2 is illustrated as being executed in FIG. 3. Specifically, a first client device 208(1) and a second client device 208(2) are illustrated as being in communication with CEAIRM device 202. In this regard, the first client device 208(1) and the second client device 208(2) may be “clients” of the CEAIRM device 202 and are described herein as such. Nevertheless, it is to be known and understood that the first client device 208(1) and/or the second client device 208(2) need not necessarily be “clients” of the CEAIRM device 202, or any entity described in association therewith herein. Any additional or alternative relationship may exist between either or both of the first client device 208(1) and the second client device 208(2) and the CEAIRM device 202, or no relationship may exist.

Further, CEAIRM device 202 is illustrated as being able to access an AI regression models data repository 206(1) and a counterfactual explanations database 206(2). The counterfactual explanations generation module 302 may be configured to access these databases for implementing a method for providing counterfactual explanations for decisions made by artificial intelligence regression models.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the CEAIRM device 202 via broadband or cellular communication. Of course, these embodiments are merely exemplary and are not limiting or exhaustive.

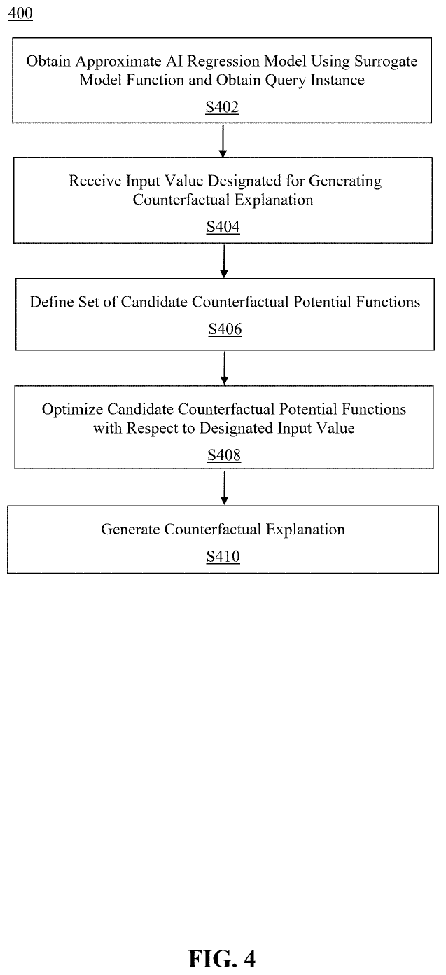

Upon being started, the counterfactual explanations generation module 302 executes a process for providing counterfactual explanations for decisions made by artificial intelligence regression models. An exemplary process for providing counterfactual explanations for decisions made by artificial intelligence regression models is generally indicated at flowchart 400 in FIG. 4.

In process 400 of FIG. 4, at step S402, the counterfactual explanations generation module 302 obtains a mathematical expression that corresponds to an approximation of an artificial intelligence (AI) regression model, also referred to herein as a surrogate model function, together with a first value that corresponds to a query instance for the AI regression model. In an exemplary embodiment, the AI regression model may be designed to receive inputs that correspond to a list of features pertaining to a credit history of a customer and to generate an output that corresponds to a predicted probability of default for that customer. In an exemplary embodiment, the AI regression model may include a neural network model, a logistic regression model, a random forest model, and/or any other suitable type of AI regression model.

At step S404, the counterfactual explanations generation module 302 receives an input value that is designated by a user for generating a counterfactual explanation. In an exemplary embodiment, a user may wish to select an input value that corresponds to a counterfactual explanation for a real-world application that is both actionable and interpretable. As such, the user may select an input value that is neither too close nor too far from the obtained query instance.

At step S406, the counterfactual explanations generation module 302 defines a set of candidate counterfactual potential functions. In an exemplary embodiment, the set of candidate counterfactual potential functions is defined based on exponential-polynomial functions of the user-selected input value.

At step S408, the counterfactual explanations generation module 302 optimizes the defined set of candidate counterfactual potential functions with respect to the designated input value selected by the user. In an exemplary embodiment, a Bayesian optimization operation is used.

At step S410, an optimum counterfactual explanation is generated based on a result of the optimization. In an exemplary embodiment, the optimum counterfactual explanation corresponds to a result of performing a differentiable continuous mapping between the respective output values of the surrogate model function and a real line over a predetermined subset of the set of real numbers so as to ensure that the designated input value selected by the user corresponds to the maximum value of the user-selected counterfactual potential function.

In an exemplary embodiment, the counterfactual explanation corresponds to an explanation of the outputs of the AI regression model, which may be expressed based on respective distances from the query instance which result in different model outputs than the model output for the query instance itself.

As AI is increasingly being adopted into many applications, the need for providing explanations for the decisions made by the AI is becoming more urgent. An important research area that aims to address this challenge focuses on counterfactual explanations (or counterfactuals), as a tool for inspecting the outputs of machine learning (ML) models. In particular, counterfactuals can be helpful to identify how a data input should be different in order for the ML model to change its output.

Definitions: The “model” is a mapping that takes values from the “input space” and produces a real-valued “output”. Concretely, the model output might be a predicted probability of default for a customer and the input may be a list of features pertaining to a customer's credit history. These features may be of arbitrary type, that is, continuous, categorical or ordinal. Neural Networks, Logistic Regression, and Random Forests are common instances of models.

A “query instance” is a member of the input space whose corresponding model output is to be explained. In the previous example, this may be the data for a particular customer. A “counterfactual” relative to this query instance is a neighboring data point in the input space that has a different output to the query instance. In the same example, this would be data for a hypothetical similar customer to the query instance, but that has a different predicted probability of default.

In binary classification settings, generating a counterfactual means switching a “Yes” output to a “No” output, or vice versa. In regression settings, it is ambiguous what constitutes a useful counterfactual due to the continuous-valued model output.

While a number of techniques have been developed for generating counterfactuals in classification setting, only limited results have been obtained in the case of regression models.

Solution: In an exemplary embodiment, the present inventive concept implements a new way to generate counterfactual examples for regression models that is efficient and applicable to black-box ML models with arbitrary input types. In particular, a potential function that maps the model output to a real number is defined that allows the user to specify how the output of the model will differ on the counterfactual example relative to its value at the query instance. The higher the value of the potential function evaluated on a particular model output, the more suitable the counterfactual.

In an exemplary embodiment, an example of such a function that favors model outputs that are at a user-specified distance from the output and disfavors outputs that are either too similar or too far away is disclosed. Computing counterfactual examples is then formulated as a composite optimization problem over the data input space, where the potential function, which is a function of the model's output, is being maximized. This optimization problem is solved using a Bayesian optimization scheme, where the surrogate for the model is a Gaussian process and the acquisition function is Expected Improvement of the potential function, evaluated on the surrogate at a given input.

The algorithm is an iterative scheme where the next input to be fed to the model as a candidate counterfactual is chosen by maximizing the Expected Improvement of the potential function over the input space and the set of all previous inputs are the generated counterfactuals. The generated input points are mathematically guaranteed to maximize the potential function as the number of iterations becomes large. The relevant algorithms to compute each iteration are obtained efficiently by analytically evaluating the Expected Improvement and its gradient for a given input. Gradient-based methods are used to maximize at each iteration of the algorithm. Once the potential value has converged, the best k (chosen by the user) values are returned as counterfactual examples.

Regression models have continuous output. This means there is no obvious notion of a decision boundary to cross to produce counterfactuals, as in the case of classification. This necessitates the need for a potential function for the model output. The higher the value of the potential function, the more useful a given data point is as a counterfactual.

In an exemplary embodiment, a “Goldilocks” potential function is provided that allows the user to specify the distance in model output, w, which is ideal from an explanation perspective. Outputs that are either too close or too far from the output at the query instance are penalized.

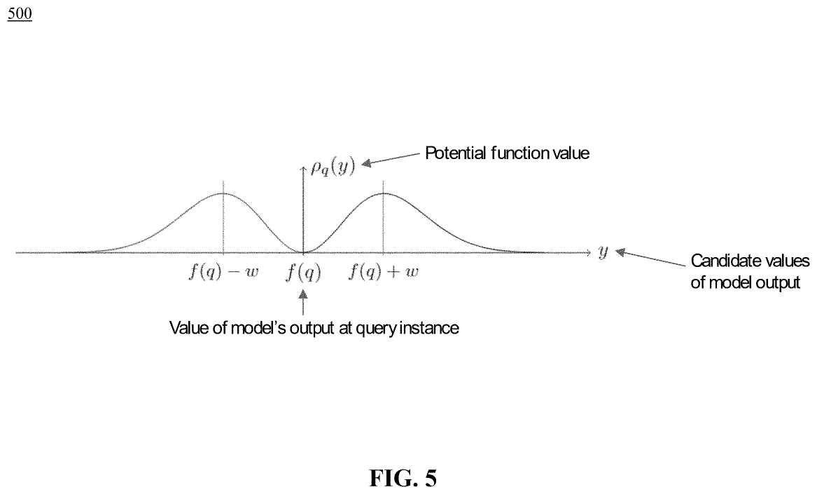

FIG. 5 is a graphical depiction 500 of an exponential-polynomial potential function that is optimizable for defining a counterfactual potential function, according to an exemplary embodiment. In an exemplary embodiment, an optimization problem may be expressed as max _{x∈X}ρ_{q}(f(x)), where the model y=f(x), the value x=q is the query instance and X is the set of all possible input data points. This is an example of a composite optimization problem.

This problem is approached by using Bayesian Optimization: 1) f(x) is approximated via a surrogate model fₛᵤᵣ(x). 2) At each iteration, a new data point xₜ is drawn, balancing the need to learn the surrogate model and maximizing ρ_{q}(f(x)). 3) It may be quickly checked if method has converged if optimum potential value exists, and if not, the method converges to best possible. 4) Any input data types are allowed for X.

The same technique can be used for for optimizing a classification potential function (e.g. ρ_{q}(y)=δ_{{y≠q}}}) and the method gives a counterfactual generation method for black-box classification models with arbitrary input data type models for free.

In an exemplary embodiment, the challenge of computing counterfactual explanations for regression models is addressed in a principled, flexible manner. In one aspect, the technique is designed for black-box regression models. The intrinsic computational complexity of the counterfactual search problem is tackled via Bayesian optimization.

Contributions: 1) The concept of a counterfactual potential function for regression models is introduced. The potential function is interpreted as higher values leading to “better” counterfactuals for a given query instance. This admits formulation of the counterfactual search problem for regression as an optimization problem. 2) Using this formulation, finding the optimal counterfactual for a regression model is proven to be CLS complete, and deciding counterfactual existence for classification models is shown. 3) A particular potential function is defined as a symmetric exponential polynomial (SEP) potential. Under the SEP potential, counterfactual search is formulated as optimizing the SEP potential evaluated on the regression model's output over some constrained region of the input space containing the query instance. 4) In an exemplary embodiment, the resulting composite optimization problem is solved by using Bayesian optimization. The regression model output is modeled as following a Gaussian process, and Expected Improvement (EI) is used as an acquisition function. Under the SEP potential function, closed form expressions for the EI integral and its derivative are provided, thus allowing for fast search of counterfactuals. 5) Theoretical and empirical results showing effectiveness of this technique are shown.

Counterfactual Search: The generation of counterfactual explanations (CFX) can be formulated as a classic search, or satisfiability problem. Given some model f: X→Y, where X is of finite dimensionality, and a query instance q∈X, the objective is to identify another input c≠q, c∈X, such that the new output qualifies as “contrary to the fact”. To formalize this, the notion of a counterfactual algebra which contains all possible subsets of a model's range, excluding f(q), is introduced. Then, a form of duality is identified between the chosen target set and the input values that could plausibly give rise to an output in this region. These two concepts characterize the problem of finding a counterfactual explanation, regardless of the domain or codomain of the model.

Definition 2.1 (Counterfactual Algebra). For a model-query pair (f,q), define the counterfactual algebra T^{f}_{q} as the Borel σ-algebra over the set {f(x): x∈X, x≠q}. Further, let Te^{f}_{q}⊂T^{f}_{q} denote the subsets that admit polynomial-time membership circuits/oracles.

Definition 2.2 (Counterfactual Duality). Take a model-query pair (f,q) and choose a target set T∈T^{f}_{q} to be the dual space. The corresponding primal (or, counterfactual) space is then defined as the preimage of the target set under f,

C_{T}^{f}≐f⁻¹[T]={x∈X:f(x)∈T}. (1)

The abbreviated notations CT and C will be used when f and/or T are clear from context.

The primal-dual construction above makes it clear that the outcome and efficacy of any counterfactual experiment hinges on (a) the nature of the domain/codomain X and Y; (b) the query instance q∈X; and (c) the choice of target set T∈T^{f}_{q}. While Definition 2.1 implies that any element x∈T is reachable under the model, it says nothing of how hard it is to find such a point. Below this problem is characterized and a showing is made that, under mild technical conditions, verifying the existence of counterfactual solutions can be achieved in polynomial time even if the task of finding a solution may be hard.

CFX-Existence (informal)

Input: A model f: X→Y, query qϵX and target set TϵT^{f}_{q}.
Goal: Decide if the counterfactual set C is non-empty.

### Theorem 2.1: CFX-Existence is NP-complete.

The assumptions underlying Theorem 2.1 are not unrealistic, as the majority of machine learning models can be evaluated efficiently—e.g. logistic regression, decision trees, neural networks—and the set Y is often finite in cardinality, yielding efficient operations for set membership.

In the classification setting, Y is indeed finite and the target set is defined as T_{q}={y∈Y:y≠f(q)}, or some subset thereof. Clearly, if |Y|≤k for some k∈N₊, then one can construct practical algorithms that solve CFX-EXISTENCE under mild constraints on the model f and its domain X. On the other hand, the regression setting is characterized by models whose codomains are subsets of an n-dimensional real vector space. In this case the very definition of a “valid” counterfactual is much more nuanced. First, there may not always be an efficient algorithm for establishing whether a value is even present in the target set, since it is defined over an uncountably infinite field. Second, it is not clear how to choose a set from the model-induced algebra so as to obtain “realistic” counterfactuals. One natural correspondence between the regression and classification settings is recovered when the counterfactual set is defined as C_{q}={x∈X: d(f(x),f(q))>ε} for a suitable distance metric d: Y X Y→R; i.e. the complement of a closed E-ball about the model output q at the query instance. This gives rise to an equivalency, since the two instances of CFX-EXISTENCE—one for a (binary) classifier and one for a regressor—would be indistinguishable from the perspective of the target set. It also solves the problem of tractability with respect to set membership, since threshold-based targets admit trivial verification algorithms. The issue with this formulation is that it makes no distinction between values in C, even though, in many cases, the validity of a counterfactual, c∈C, decreases as the distance d(f(c),f(q)) grows beyond the tolerance E.

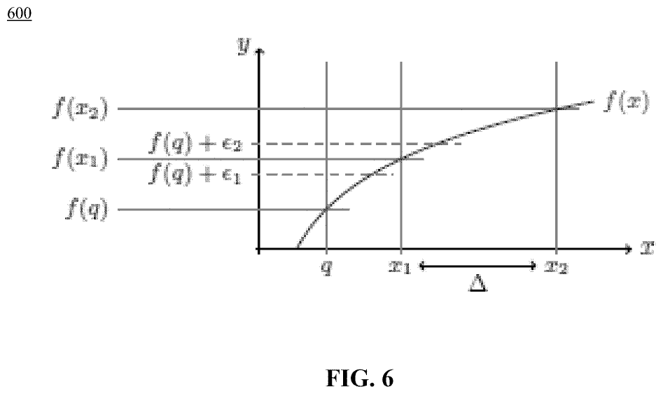

FIG. 6 is a graphical illustration 600 of a sensitivity of defining a counterfactual for regression via a threshold, according to an exemplary embodiment. Referring to FIG. 6, an illustration 600 of how defining counterfactuals for regression via a threshold can lead to a lack of robustness is shown. Choosing ϵ₂ in lieu of ϵ₁ as a threshold for defining a counterfactual returns x₂ as opposed to x₁ as the counterfactual. In the limit of large Δ, x₁ may be preferred as the corresponding output f(x₁) is “close enough” to the threshold ϵ₂.

As a concrete example, consider a threshold E for which counterfactuals must satisfy the condition: d(f(x),f(q))≥l, where X=Y=R and d is the l₁-distance. Here a problem arises whereby the returned counterfactuals can be very sensitive to ϵ, as illustrated in FIG. 5. Suppose that q<x₁<x₂ and f is monotone increasing such that f(q)<f(q)+e₁<f(x₁)<f(q)+e₂<f(x₂) for 0<ϵ₁<ϵ₂. Moreover, let |x₂−x₁|=Δ and q be the query instance. In this scenario, if ϵ₁ is used as the threshold, then x₁ would be returned as a counterfactual, otherwise ϵ₂ would be chosen and X2 would be returned. In the limit when Δ is large, x₂ is so far from q that it bears little relation to the query instance and ϵ₂ is thus a poorly chosen threshold. Indeed, when f(q)+e₂−f(x₁) is small, f(x₁) is close enough to the threshold value f(q)+ϵ₂ that x₁ may well be more useful as a counterfactual to q, as compared with x₂. Ex ante, there is no way to choose between ϵ₁ and ϵ₂ in such a way to mitigate this threshold robustness issue. In an exemplary embodiment, the notion of regression counterfactuals is formalized in terms of potential functions instead of the direct instantiation of the primal-dual spaces via thresholds.

Potential-Based Search: In an exemplary embodiment, a subset of [symbol] is provided: for a given query q∈X, a scalar potential is ascribed to each y∈Y, which quantifies the value associated with counterfactual points. This concept is closely related to a construction used in potential games to analyze equilibria when agents' incentives are dictated by a single global function. The following definition formalizes this concept by which there is a key requirement that potential functions must be “well-behaved”.

Definition 2.3 (Potential Function): For a model-query pair (f,q) and tolerance ε≥0, the characteristic set is defined as follows:

$${R}_{q , ε}^{f} ≐ \{ ρ ∈ {C}_{L}^{1} ( y , ℝ ) : {max}_{x ∈ 𝒳} ρ ( f ( x ) ) - ρ ( f ( q ) ) > ε \} , \qquad ( 2 )$$

as the set of all continuously differentiable mappings, ρ∈ [symbol] _{q,ε}^{f} between model outputs and the real line, where ρ and ∇ρ are L-Lipschitz and the maximum value over the range of the model is bounded away from the query output by ε. A counterfactual potential function, or valid potential function, ρ∈R_{q,ε}^{f} is any member of the characteristic set.

These functions offer an alternative means of specifying the counterfactual sets for regression models as they imply a partial ordering over the domain. To leverage this, a corresponding refinement of the counterfactual duality specified in Definition 2.2.

Definition 2.4 (Potential Duality). For a model-query pair (f,q) and potential function ρ∈R^{f}_{q,ε}, we define the E-optimal primal-dual spaces as

[symbol]

_{ρ}^{ε}≐{y=f(x):x∈X,ρ(y)≥ρ*−ε}∈X _{ρ}^{f}⊂ [symbol] _{q}^{f} (3)

C_{ρ}^{ε}≐{x∈X:f(x)∈T_{q}^{ε}}, (4)

where ρ*=max_{x∈X}ρ(f(x)) and ε≥0. This implies that there exists a sub-algebra of (potential based) target sets, T^{f}_{ρ}⊂T^{f}_{q}, which is given by the Borel σ-algebra over the (ρ*-ε)-superlevel sets. As in Definition 2.1, let Te^{f}_{ρ}=T^{f}_{ρ}∩Te^{f}_{q}.

While this formalism does not cover all possible counterfactual search problems—e.g. for discrete Y or when T_{q} are expressed using step functions—it does provide a natural way of specifying the search objective for regression models. In particular, it allows a recasting of what is fundamentally a search problem into an explicit optimization problem, where the goal is to find one or more points in a given counterfactual set C_{q}^{ε}. When the model f has a well-behaved differentiable form, one can use gradient-based methods to find a counterfactual by solving for a fixed-point of a recurrence relation such as

xₙ₊₁←Π_{X}[xₙ+η∇ρ(f(xₙ))]=Π_{X}[xₙ+ηρ⁰(f(xₙ))^{>}f⁰(xₙ)], (5)

where Π_{X} denotes a (Euclidean) projection onto X, and noting that the potential function is being maximized. Of course, this often fails to hold in practice since many machine learning models, such as boosted decision trees, are not differentiable or even continuous. Further, there exist myriad cases where gradient-based methods fail with high probability even if ∇f exists.

CFX-Potential-Search (Informal)

Input: A differentiable model f: Rⁿ→Rₘ, potential ρ: R^{m}→R and tolerance ϵ>0.
Goal: Find an element of the counterfactual (primal) set C_{ρ}^{ε}

### Theorem 2.2: CFX-Potential-Search is CLS-complete.

“Goldilocks” Potential Functions: An important desideratum for potential functions is that they encourage points away from the query instance q∈X while simultaneously discouraging points that deviate too far and become unrealistic (or perhaps off-manifold). This “Goldilocks” property is crucial to many real-world applications where the explanations need to be both actionable and interpretable. One natural way to achieve this, while maintaining differentiability, is to use exponential-polynomials for which the following definition is provided:

Definition 2.5 (EP Family). For Y⊆R, the symmetric exponential-polynomial (SEP) potential function is defined as

$${ρ}_{q}^{SEP} ( y ; w ) ≐ {{z}_{q} ( y ; w )}^{2} exp \{ - {{z}_{q} ( y ; w )}^{2} \} , where {z}_{q} ( y ; w ) ≐ \frac{y - f ( q )}{w} \qquad ( 6 )$$

and w>0 is a positive width parameter. The asymmetric exponential-polynomial (AEP) potential functions are then defined by taking only the positive or negative parts of z_{q} such that ρ_{SEP}_{_{q}}(y;w)=ρ_{AEP}_{_{q+}}(y;w)+ρ_{AEP}_{_{q−}}(y;w). Lemma 2.3 The exponential-polynomial (EP) family are valid potential functions for 0≤ε<1/e.

The EP family is particularly well-suited to describing counterfactuals since the optima are easily manipulated. Moreover, the shape—specifically, the superlevel sets—of the functions ensures that there is a sensible preference over alternative counterfactuals should the maxima not be present in the preimage. In an exemplary embodiment, an example instance of the exponential-polynomial family has a maximum value that is achieved precisely at a deviation of ±w from f(q); i.e., argmax_{y∈Y} p(y)=f(q)±w, where the directions of ±depends on the choice of symmetry/asymmetry. It follows from these observations that the ε-optimal target sets form an annulus of radius w under the SEP potential function. Further, since AEP potentials are both quasi-concave, these sets are convex, which is a particularly favorable property for gradient-based search.

Bayesian Optimization and the EI-CFX Algorithm:

As outlined above, an optimization perspective is taken on the problem of finding counterfactual explanations. However, instead of attempting to avoid the requirement that the model be differentiable itself, in an exemplary embodiment, the search is performed over the posterior distribution of a Gaussian process (GP) surrogate. This allows us for identifying counterfactuals for a much wider class of models. Though there is still a reliance on gradient-based methods within the algorithm, optimizing a GP posterior with a smooth kernel can be much more efficient. This is especially true in cases where the model exhibits discontinuities or only admits subdifferentials; e.g. decision trees. The first question that arises, then, is how to model the composition of f and ρ, for which there are two available options: (a) model the composition as a black-box; or (b) model only f with the GP and pass the result through ρ in a post-hoc fashion. In an exemplary embodiment, the latter is deemed as being much more effective as it leverages more information. This will also turn out to be key to the ability to perform parallelized search. First, in an exemplary embodiment, a proposed method is formalized in the language of Bayesian optimization.

Take a scalar regression model f: X→R and define a surrogate \hat{f} as being drawn from a GP prior, GP(μ,K), with mean function. μ:X→R and covariance function K:X×X→R₊. Given a dataset Dₙ={(xᵢf(xᵢ))}_{i∈[n]}, the posterior distribution can be computed, denoted by GP(μₙ,Kₙ), where the conditioned mean and covariance functions, μₙ: X→R and Kₙ: X→R, can be evaluated in closed form. Denote also by ρ⁺ₙ=max{y:(x,y)∈Dₙ} the maximum potential observed after collecting n samples. In an exemplary embodiment, a novel acquisition function for performing (potential-based) counterfactual search then follows by a refinement of the well-known expected improvement function. As shown below in Proposition 3.1, this function also admits “well-behaved,” closed-form expressions for its value and derivative.

Definition 3.1 (Expected Counterfactual Improvement). For a surrogate-potential pair (\hat{f},ρ), define the expected counterfactual improvement as

$$\begin{matrix}EI - CFX {n}_{ρ}^{} ( x ) & ≐ & {𝔼}_{n} [ max \{ 0 , ρ ◦ \hat{f} ( x ) - {ρ}_{n}^{*} \} ] , & ( 7 ) \\ & = & \frac{1}{{σ}_{n} ( x )} {\int }_{ℝ} max \{ 0 , ρ ( y ) - {ρ}_{n}^{*} \} ϕ ( \frac{y - {μ}_{n} ( x )}{{σ}_{n} ( x )} ) d y , & \end{matrix}$$

where Eₙ[X]=E[X|Dₙ], the function σₙ(x)≐\sqrt{Kₙ(x,x)} denotes the standard deviation at x, and by φ: R→R the PDF of the standard Normal distribution.

Proposition 3.1: EI-CFX and its derivative admit closed-form expressions that are continuous in X.

By virtue of this construction—namely, the use of a composite structure—it can also be shown that Bayesian optimization using EI-CFX converges asymptotically to a globally optimum counterfactual. In other words, in an exemplary embodiment, assuming that the counterfactual set C_{q} is non-empty, this proposed algorithm is guaranteed to find a point c∈C_{q} in the limit as the dataset grows infinitely large. This result establishes this algorithm as the first method for finding counterfactual explanations for regression models with global convergence guarantees. The fact that this proof holds even for non-differentiable models is a key advantage over conventional approaches and motivates a wider adoption of Bayesian optimization for solving instances of CFXPOTENTIAL-SEARCH and related problems in this area.

Theorem 3.2. The EI-CFX acquisition function is asymptotically consistent.

Accordingly, with this technology, an optimized process for providing counterfactual explanations for decisions made by artificial intelligence regression models is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for generating a counterfactual explanation for an artificial intelligence (AI) regression model, the method being implemented by at least one processor, the method comprising:
obtaining, by the at least one processor, a mathematical expression that corresponds to the AI regression model and a first value that corresponds to a query instance;
defining, by the at least one processor, at least one candidate counterfactual potential function by performing a differential continuous mapping between respective output values of the obtained mathematical expression and a real line over a predetermined subset of real numbers; and
generating the counterfactual explanation based on at least one respective value of the obtained mathematical expression that corresponds to a maximum value of the defined at least one candidate counterfactual potential function.

2. The method of claim 1, wherein the generating of the counterfactual explanation further comprises:
selecting, from among a predetermined set of possible input data points, a first data point to be used as an input to the obtained mathematical expression;
computing a corresponding output value of the obtained mathematical expression based on the selected first data point;
determining whether the computed corresponding output value corresponds to a predetermined optimum potential value; and
when the computed corresponding output value is determined as corresponding to the predetermined optimum potential value, generating the counterfactual explanation based on the selected first data point.

3. The method of claim 2, wherein when the computed corresponding output value is determined as not corresponding to the predetermined optimum potential value, the method further comprises:
selecting a next data point from among the predetermined set of possible input data points to be used as an input to the obtained mathematical expression;
computing a next corresponding output value of the obtained mathematical expression based on the selected next data point;
determining whether the next computed corresponding output value corresponds to the predetermined optimum potential value;
when the next computed corresponding output value is determined as corresponding to the predetermined optimum potential value, generating the counterfactual explanation based on the most recently selected next data point; and
when the next computed corresponding output value is determined as not corresponding to the predetermined optimum potential value, repeating the selecting, computing, and determining steps for additional next data points until the computed corresponding value is determined as corresponding to the predetermined optimum potential value.

4. The method of claim 1, further comprising:
receiving, by the at least one processor from a user, an input value designated by the user for generating the counterfactual explanation,
wherein the defining of the at least one candidate counterfactual potential function comprises performing the differential continuous mapping between the respective output values of the obtained mathematical expression and the real line over the predetermined subset of real numbers such that the input value designated by the user corresponds to the maximum value of the defined at least one candidate counterfactual potential function.

5. The method of claim 4, wherein the defining of the at least one candidate counterfactual potential function further comprises:
determining a plurality of candidate counterfactual potential functions;
optimizing the determined plurality of candidate counterfactual potential functions with respect to the input value designated by the user; and
generating the counterfactual explanation based on a result of the optimizing.

6. The method of claim 5, wherein the optimizing comprises using Bayesian optimization to perform the optimizing.

7. The method of claim 5, wherein the determining of the plurality of candidate counterfactual potential functions comprises defining a plurality of exponential-polynomial functions of the input value designated by the user.

8. The method of claim 1, wherein the AI regression model includes at least one from among a neural network model, a logistic regression model, and a random forest model.

9. A computing apparatus for generating a counterfactual explanation for an artificial intelligence (AI) regression model, the computing apparatus comprising:
a processor;
a memory; and
a communication interface coupled to each of the processor and the memory,
wherein the processor is configured to:
obtain a mathematical expression that corresponds to the AI regression model and a first value that corresponds to a query instance;
define at least one candidate counterfactual potential function by performing a differential continuous mapping between respective output values of the obtained mathematical expression and a real line over a predetermined subset of real numbers; and
generate the counterfactual explanation based on at least one respective value of the obtained mathematical expression that corresponds to a maximum value of the defined at least one candidate counterfactual potential function.

10. The computing apparatus of claim 9, wherein the processor is further configured to generate the counterfactual explanation by:
selecting, from among a predetermined set of possible input data points, a first data point to be used as an input to the obtained mathematical expression;
computing a corresponding output value of the obtained mathematical expression based on the selected first data point;
determining whether the computed corresponding output value corresponds to a predetermined optimum potential value; and
when the computed corresponding output value is determined as corresponding to the predetermined optimum potential value, generating the counterfactual explanation based on the selected first data point.

11. The computing apparatus of claim 10, wherein when the computed corresponding output value is determined as not corresponding to the predetermined optimum potential value, the processor is further configured to:
select a next data point from among the predetermined set of possible input data points to be used as an input to the obtained mathematical expression;
compute a next corresponding output value of the obtained mathematical expression based on the selected next data point;
determine whether the next computed corresponding output value corresponds to the predetermined optimum potential value;
when the next computed corresponding output value is determined as corresponding to the predetermined optimum potential value, generate the counterfactual explanation based on the most recently selected next data point; and
when the next computed corresponding output value is determined as not corresponding to the predetermined optimum potential value, repeat the selecting, computing, and determining operations for additional next data points until the computed corresponding value is determined as corresponding to the predetermined optimum potential value.

12. The computing apparatus of claim 9, wherein the processor is further configured to:
receive, from a user via the communication interface, an input value designated by the user for generating the counterfactual explanation; and
define the at least one candidate counterfactual potential function by performing the differential continuous mapping between the respective output values of the obtained mathematical expression and the real line over the predetermined subset of real numbers such that the input value designated by the user corresponds to the maximum value of the defined at least one candidate counterfactual potential function.

13. The computing apparatus of claim 12, wherein the processor is further configured to define the at least one candidate counterfactual potential function by:
determining a plurality of candidate counterfactual potential functions;
optimizing the determined plurality of candidate counterfactual potential functions with respect to the input value designated by the user; and
generating the counterfactual explanation based on a result of the optimizing.

14. The computing apparatus of claim 13, wherein the processor is further configured to use Bayesian optimization to perform the optimization.

15. The computing apparatus of claim 13, wherein the processor is further configured to determine the plurality of candidate counterfactual potential functions by defining a plurality of exponential-polynomial functions of the input value designated by the user.

16. The computing apparatus of claim 9, wherein the AI regression model includes at least one from among a neural network model, a logistic regression model, and a random forest model.

17. A non-transitory computer readable storage medium storing instructions for generating a counterfactual explanation for an artificial intelligence (AI) regression model, the storage medium comprising executable code which, when executed by a processor, causes the processor to:
obtain a mathematical expression that corresponds to the AI regression model and a first value that corresponds to a query instance;
define at least one candidate counterfactual potential function by performing a differential continuous mapping between respective output values of the obtained mathematical expression and a real line over a predetermined subset of real numbers; and
generate the counterfactual explanation based on at least one respective value of the obtained mathematical expression that corresponds to a maximum value of the defined at least one candidate counterfactual potential function.

18. The storage medium of claim 17, wherein the executable code is further configured to cause the processor to:
select, from among a predetermined set of possible input data points, a first data point to be used as an input to the obtained mathematical expression;
compute a corresponding output value of the obtained mathematical expression based on the selected first data point;
determine whether the computed corresponding output value corresponds to a predetermined optimum potential value; and
when the computed corresponding output value is determined as corresponding to the predetermined optimum potential value, generate the counterfactual explanation based on the selected first data point.

19. The storage medium of claim 18, wherein when the computed corresponding output value is determined as not corresponding to the predetermined optimum potential value, the executable code is further configured to cause the processor to:
select a next data point from among the predetermined set of possible input data points to be used as an input to the obtained mathematical expression;
compute a next corresponding output value of the obtained mathematical expression based on the selected next data point;
determine whether the next computed corresponding output value corresponds to the predetermined optimum potential value;
when the next computed corresponding output value is determined as corresponding to the predetermined optimum potential value, generate the counterfactual explanation based on the most recently selected next data point; and
when the next computed corresponding output value is determined as not corresponding to the predetermined optimum potential value, repeat the selecting, computing, and determining steps for additional next data points until the computed corresponding value is determined as corresponding to the predetermined optimum potential value.

20. The storage medium of claim 17, wherein the executable code is further configured to cause the processor to:
receive, from a user, an input value designated by the user for generating the counterfactual explanation; and
define the at least one candidate counterfactual potential function by performing the differential continuous mapping between the respective output values of the obtained mathematical expression and the real line over the predetermined subset of real numbers such that the input value designated by the user corresponds to the maximum value of the defined at least one candidate counterfactual potential function.
